(19) United States
(12) Patent Application Publication
(10) Pub. No.: US 2024/0242425 A1
(43) Pub. Date: Jul. 18, 2024

(54) ESTIMATION OF ANOMALIES USING A THREE-DIMENSIONAL MODEL OF AN ENVIRONMENT

(71) Applicant: Aalto University Foundation sr, Aalto (FI)

(72) Inventor: Siavash Haghighat Khajavi, Aalto (FI)

(73) Assignee: Aalto University Foundation sr, Aalto (FI)

(21) Appl. No.: 18/154,082

(22) Filed: Jan. 13, 2023

(51) Int. Cl. G06T 17/00; G01J 5/48; G06T 7/62; G06T 7/70; G08B 21/00

(52) U.S. Cl. CPC G06T 17/00; G01J 5/48; G06T 7/62; G06T 7/70; G08B 21/00

(57) ABSTRACT

F estimating an anomaly in an environment a dimensionally accurate three-dimensional model associated with the environment is obtained from a memory, providing a three-dimensional position of objects in the environment. Thermal sensor data originating from a thermal sensor and image sensor data originating from an image sensor arranged in the environment is obtained. The thermal sensor data and image sensor data includes real-time image data associated with the environment, the thermal sensor and image sensor having known locations in the dimensionally accurate three-dimensional model. Locations of image pixels in the thermal sensor data, the image sensor data and a point of view of a camera associated with the dimensionally accurate three-dimensional model are mapped, and one of a location and size of an anomaly indicated by the thermal sensor data is estimated, the anomaly being associated with an object in the dimensionally accurate three-dimensional model based on the mapping.

### TECHNICAL FIELD

Various example embodiments generally relate to the field of estimating anomalies in an environment. In particular, some example embodiments relate to a solution for using a three-dimensional model of the environment when estimating anomalies in the environment.

### BACKGROUND

Various anomalies may be detected in an environment, for example, in an indoor environment using various sensors. Based on data, for example, from thermal sensors, cameras, smoke sensors etc., an anomaly may be detected. An anomaly may refer, for example, overheating of a system element, a fire etc. Depending on the anomaly, an action may be taken. For example, a smoke sensor or a thermal sensor may trigger a fire alarm, or a thermal sensor may trigger an emergency shutdown of a system.

In an anomaly situation and especially in an event of a fire, although image and sensor data may be available, it may still be difficult to determine or estimate the degree or enormity of the event in real-time. Therefore, a solution providing a better real-time estimation is needed.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments may provide a solution that enables an estimation of the size and/or location of an anomaly in a dimensionally accurate three-dimensional model. This benefit may be achieved by the features of the independent claims. Further implementation forms are provided in the dependent claims, the description, and the drawings.

According to a first aspect, there is provided a computer-implemented method for estimating an anomaly in an environment. The method comprises obtaining, from a memory, a dimensionally accurate three-dimensional model associated with the environment, the dimensionally accurate three-dimensional model providing a three-dimensional position of objects in the environment; obtaining thermal sensor data originating from a thermal sensor and image sensor data originating from an image sensor arranged in the environment, the thermal sensor data and image sensor data comprising substantially real-time sensor data associated with the environment, the thermal sensor and image sensor having known locations in the dimensionally accurate three-dimensional model; mapping locations of image pixels in the thermal sensor data, the image sensor data and a point of view of a camera associated with the dimensionally accurate three-dimensional model; and estimating at least one of a location and size of an anomaly indicated by the thermal sensor based on the mapping, the anomaly being associated with an object in the dimensionally accurate three-dimensional model.

In an example embodiment of the first aspect, the method further comprises visualizing the anomaly associated with the object in the dimensionally accurate three-dimensional model.

In an example embodiment of the first aspect, the method further comprises triggering an alarm associated with the anomaly associated with the object in the dimensionally accurate three-dimensional model.

In an example embodiment of the first aspect, the method further comprises detecting that one or more pixels in the thermal sensor data originating from the thermal sensor triggers at least one threshold associated with the one or more pixels; identifying the corresponding one or more pixels in the image sensor data originating from the image sensor; mapping at least part of the corresponding one or more pixels in the image sensor data to at least one pixel of a surface of an object in the dimensionally accurate three-dimensional model; and estimating the at least one of location and size of the anomaly associated with the surface of the object in the dimensionally accurate three-dimensional model based on the mapping.

In an example embodiment of the first aspect, the method further comprises determining a two-dimensional point of view of a camera in the dimensionally accurate three-dimensional model associated with the environment based on the image sensor data and a location of the image sensor the in environment; mapping the corresponding one or more pixels in the image sensor data to the two-dimensional point of view of the camera in the dimensionally accurate three-dimensional model associated with the environment; determining one or more pixels associated with the surface of the object that correspond with the at least part of the corresponding one or more pixels in the image sensor data; and estimating the at least one of location and size of the anomaly associated with the surface of the object in the dimensionally accurate three-dimensional model based on the one or more pixels associated with the surface of the object.

In an example embodiment of the first aspect, the method further comprises obtaining, from the memory, a normal operational signature associated with the environment, the normal operational signature determining at least one threshold associated with each pixel of the thermal sensor data.

In an example embodiment of the first aspect, the at least one threshold associated with each pixel of the thermal sensor data comprises at least one of: a lower temperature boundary for each pixel of the thermal sensor data; an upper temperature boundary for each pixel of the thermal sensor data; a rate of a temperature change for each pixel of the thermal sensor data; and a timing or sequence of change for each pixel of the thermal sensor data.

In an example embodiment of the first aspect, the at least one threshold associated with each pixel of the thermal sensor data is normalized, and the method further comprises obtaining depth map data based on the dimensionally accurate three-dimensional model; and normalizing the thermal sensor data originating from the thermal to enable comparison to the at least one threshold associated with each pixel of the thermal sensor data.

In an example embodiment of the first aspect, the method further comprises obtaining, from the memory, at least one three-dimensional exclusion zone associated with the dimensionally accurate three-dimensional model associated with the environment; and excluding a volume determined by the at least one three-dimensional exclusion zone when estimating the at least one of location and size of the anomaly associated with the object in the dimensionally accurate three-dimensional model based on the mapping.

In an example embodiment of the first aspect, the method further comprises storing the thermal sensor data and image sensor data in the memory for historical analysis; integrating the stored data to the dimensionally accurate three dimensional model; processing the stored data using a risk assessment model to determine a time dependent risk score associated with the environment; and providing the time dependent risk score associated with the environment.

In an example embodiment of the first aspect, the method further comprises displaying the time dependent risk score in the dimensionally accurate three-dimensional model.

In an example embodiment of the first aspect, the method further comprises triggering an alarm if the time dependent risk score reaches a predetermined threshold.

According to a second aspect, there is provided an apparatus comprising at least one processor and at least one memory storing instructions, that when executed by the at least one processor, cause the apparatus to perform: obtaining, from a memory, a dimensionally accurate three-dimensional model associated with the environment, the dimensionally accurate three-dimensional model providing a three-dimensional position of objects in the environment; obtaining thermal sensor data originating from a thermal sensor and image sensor data originating from an image sensor arranged in the environment, the thermal sensor data and image sensor data comprising substantially real-time sensor data associated with the environment, the thermal sensor and image sensor having known locations in the dimensionally accurate three-dimensional model; mapping locations of image pixels in the thermal sensor data, the image sensor data and a point of view of a camera associated with the dimensionally accurate three-dimensional model; and estimating at least one of a location and size of an anomaly indicated by the thermal sensor data based on the mapping, the anomaly being associated with an object in the dimensionally accurate three-dimensional model.

In an example embodiment of the second aspect, the instructions, when executed by the at least one processor, cause the apparatus to perform: visualizing the anomaly associated with the object in the dimensionally accurate three-dimensional model.

In an example embodiment of the second aspect, the instructions, when executed by the at least one processor, cause the apparatus to perform: triggering an alarm associated with the anomaly associated with the object in the dimensionally accurate three-dimensional model.

In an example embodiment of the second aspect, the instructions, when executed by the at least one processor, cause the apparatus to perform: detecting that one or more pixels in the thermal sensor data originating from the thermal sensor triggers at least one threshold associated with the one or more pixels; identifying the corresponding one or more pixels in the image sensor data originating from the image sensor; mapping at least part of the corresponding one or more pixels in the image sensor data to at least one pixel of a surface of an object in the dimensionally accurate three-dimensional model; and estimating the at least one of location and size of the anomaly associated with the surface of the object in the dimensionally accurate three-dimensional model based on the mapping.

In an example embodiment of the second aspect, the instructions, when executed by the at least one processor, cause the apparatus to perform: determining a two-dimensional point of view of a camera in the dimensionally accurate three-dimensional model associated with the environment based on the image sensor data and a location of the image sensor in the environment; mapping the corresponding one or more pixels in the image sensor data to the two-dimensional point of view of the camera in the dimensionally accurate three-dimensional model associated with the environment; determining one or more pixels associated with the surface of the object that correspond with the at least part of the corresponding one or more pixels in the image sensor data; and estimating the at least one of location and size of the anomaly associated with the surface of the object in the dimensionally accurate three-dimensional model based on the one or more pixels associated with the surface of the object.

In an example embodiment of the second aspect, the instructions, when executed by the at least one processor, cause the apparatus to perform: obtaining, from a memory, a normal operational signature associated with the environment, the normal operational signature determining at least one threshold associated with each pixel of the thermal sensor data.

In an example embodiment of the second aspect, the at least one threshold associated with each pixel of the thermal sensor data comprises at least one of: a lower temperature boundary for each pixel of the thermal sensor data; an upper temperature boundary for each pixel of the thermal sensor data; a rate of a temperature change for each pixel of the thermal sensor data; and a timing or sequence of change for each pixel of the thermal sensor data.

In an example embodiment of the second aspect, the at least one threshold associated with each pixel of the thermal sensor data is normalized, and the instructions, when executed by the at least one processor, cause the apparatus to perform: obtaining depth map data based on the dimensionally accurate three-dimensional model; and normalizing the thermal sensor data originating from the thermal to enable comparison to the at least one threshold associated with each pixel of the thermal sensor data.

In an example embodiment of the second aspect, the instructions, when executed by the at least one processor, cause the apparatus to perform: obtaining, from the memory, at least one three-dimensional exclusion zone associated with the dimensionally accurate three-dimensional model associated with the environment; and excluding a volume determined by the at least one three-dimensional exclusion zone when estimating the at least one of location and size of the anomaly associated with the object in the dimensionally accurate three-dimensional model based on the mapping.

In an example embodiment of the second aspect, the instructions, when executed by the at least one processor, cause the apparatus to perform: storing the thermal sensor data and image sensor data in the memory for historical analysis; integrating the stored data to the dimensionally accurate three dimensional model; processing the stored data using a risk assessment model to determine a time dependent risk score associated with the environment; and providing the time dependent risk score associated with the environment.

In an example embodiment of the second aspect, the instructions, when executed by the at least one processor, cause the apparatus to perform: displaying the time dependent risk score in the dimensionally accurate three-dimensional model.

In an example embodiment of the second aspect, the instructions, when executed by the at least one processor, cause the apparatus to perform: triggering an alarm if the time dependent risk score reaches a predetermined threshold.

According to a third aspect, there is provided a system comprising a thermal sensor configured to provide substantially real-time thermal sensor data associated with an environment, the thermal sensor having a known location with respect to a dimensionally accurate three-dimensional model associated with the environment; an image sensor configured to provide substantially real-time image sensor data associated with the environment, the image sensor having a known location with respect to the dimensionally accurate three-dimensional model associated with the environment; a memory comprising the dimensionally accurate three-dimensional model associated with the environment; and an apparatus of the second aspect.

According to a fourth aspect a computer program comprises instructions for causing an apparatus to carry out the method of the first aspect.

According to a fifth aspect a computer readable medium comprises a computer program comprising instructions for causing an apparatus to carry out the method of the first aspect.

According to a sixth aspect, an apparatus may comprise means for: obtaining, from a memory, a dimensionally accurate three-dimensional model associated with the environment, the dimensionally accurate three-dimensional model providing a three-dimensional position of objects in the environment; obtaining thermal sensor data originating from a thermal sensor and image sensor data originating from an image sensor arranged in the environment, the thermal sensor data and image sensor data comprising substantially real-time sensor data associated with the environment, the thermal sensor and image sensor having known locations in the dimensionally accurate three-dimensional model; mapping the location of image pixels in the thermal sensor data, the image sensor data and a point of view of a camera associated with the dimensionally accurate three-dimensional model; and estimating at least one of a location and size of an anomaly indicated by the thermal sensor data based on the mapping, the anomaly being associated with an object in the dimensionally accurate three-dimensional model.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments.

In the drawings:

FIG. 1 illustrates an example of a method according to an example embodiment.

FIG. 2 illustrates a system according to an example embodiment.

FIG. 3 illustrates an example view of a dimensionally accurate three-dimensional model according to an example embodiment.

FIG. 4A illustrates an example of a visible light sensor image of a dryer according to an example embodiment.

FIG. 4B illustrates an example of a thermal sensor image of a dryer according to an example embodiment.

FIG. 4C illustrates an example of a dimensionally accurate three dimensional model of a dryer according to an example embodiment.

FIG. 5A illustrates an example of a visible light sensor image of a grain dryer according to an example embodiment.

FIG. 5B illustrates an example of a thermal sensor image of a grain dryer according to example embodiment.

FIG. 5C illustrates an example of a dimensionally accurate three dimensional model of a dryer according to an example embodiment.

FIG. 6 illustrates an example of an apparatus configured to practice one or more example embodiments.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms, in which the present example may be constructed or utilized. The description sets forth the functions of the example and the sequence of steps for constructing and operating the example. However, the same or equivalent functions and sequences may be accomplished by different examples.

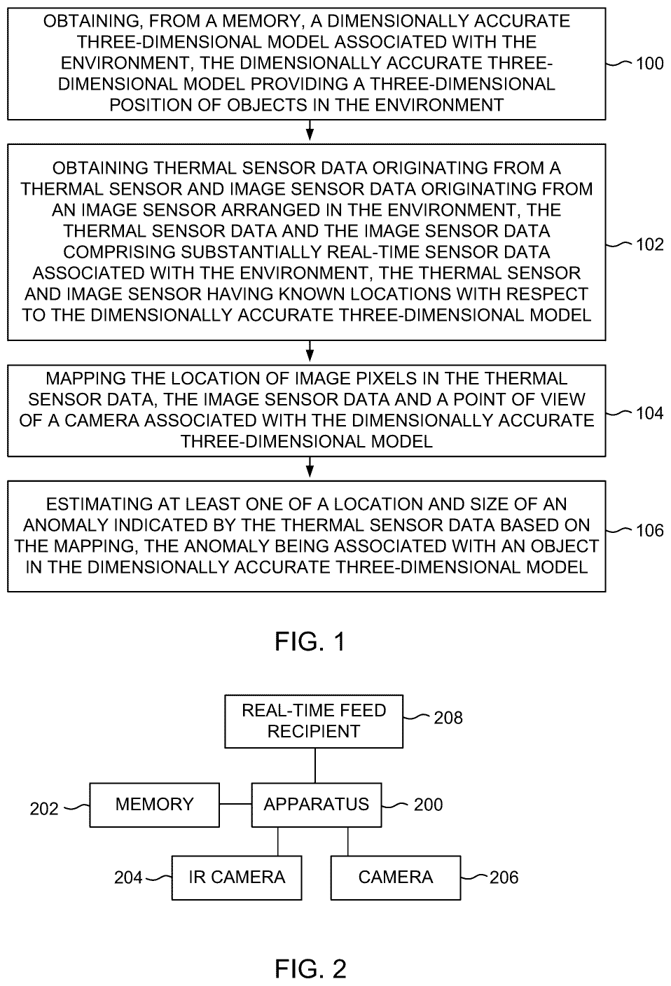

FIG. 1 illustrates an example of a method for detecting and/or estimating an anomaly according to an example embodiment. The method may be implemented by an apparatus, for example, a computer or a cloud server.

At 100 a dimensionally accurate three-dimensional model associated with the environment is obtained from a memory. The dimensionally accurate three-dimensional model provides a three-dimensional model and may provide a three-dimensional position of objects in the environment. The dimensionally accurate three-dimensional model may be created using technique that is able to provide accurate three-dimensional model data of the environment, for example, using lidar or any other three-dimensional scanning solution. The dimensionally accurate three-dimensional model associated with the environment may then be created based on this data using, for example, a 3D modeling software. The environment may refer, for example, to an open space, a closed space or a partially closed space, for example, a room, an industrial hall or to any other open or closed environment. The modelling of the environment may be performed only once, if the environment is static or nearly static. In another example embodiment, the modelling of the environment may be performed at certain intervals or after the environment has changed so that the dimensionally accurate three-dimensional model provides an up to date modelled view of the environment.

In an example embodiment, objects in the image sensor data may be recognized based on image recognition, for example, based on a machine learning algorithm. In another example embodiment, the objects may be pre-annotated in the dimensionally accurate three-dimensional model.

At 102 thermal sensor data originating from a thermal sensor and image sensor data originating from an image sensor arranged in the environment may be obtained. The thermal sensor data and image sensor data may comprise substantially real-time sensor data associated with the environment. The thermal sensor may be any sensor that is able to provide thermal data, for example, an infrared sensor or an infrared camera. The image sensor may refer, for example, to an RGB camera. The thermal sensor and the image sensor may be arranged in a single sensor package close to each other. The locations of the thermal sensor and the image sensor are known with respect to the dimensionally accurate three-dimensional model.

At 104 the location of image pixels in the thermal sensor data, the image sensor data and a point of view of a camera associated with the dimensionally accurate three-dimensional model are mapped. In other words, using the thermal sensor data the location of a pixel in the thermal sensor data can be determined in the dimensionally accurate three-dimensional model with the aid of the image sensor data provided by the image sensor.

At 106 a location and/or size of an anomaly indicated by the thermal sensor data and associated with object in an the dimensionally accurate three-dimensional model may be estimated based on the mapping. In other words, the thermal sensor data provides temperature information that can be accurately mapped to an object in the dimensionally accurate three-dimensional model. The anomaly may refer, for example, to a fire or a temperature change associated with at least one object in the dimensionally accurate three-dimensional model.

The solution discussed above may enable, for example, detection and visualization of a fire using the dimensionally accurate three-dimensional model in real-time or substantially in real-time. As the thermal sensor data and the image sensor data provided by the thermal sensor and the image sensor are provided substantially real-time and the fire can be accurately located in the dimensionally accurate three-dimensional model, this may provide valuable information, for example, to the fire brigade. In addition to fire detection and localization, the solution may be used to detect and localize changes in temperature. For example, if it is determined that a specific section being associated with a machine in the dimensionally accurate three-dimensional model is colder than normally, it may be an indication of a malfunction of the machine as it may not be running any more.

FIG. 2 illustrates an example of a system according to an example embodiment. The system comprises an apparatus 200 that may be configured to implement the method discussed above relating to FIG. 1. The system further comprises a thermal sensor 204, for example, an infrared camera and image sensor 206, for example, a visible light camera, for example, an RGB camera. The apparatus 200 is configured to receive sensor data from the infrared camera 204 and the visible light camera 206 substantially in real-time. The system also comprises a memory 202 that may store a dimensionally accurate three-dimensional model associated with an environment, the dimensionally accurate three-dimensional model providing a three-dimensional position of objects in the environment. The memory 202 may be part of the apparatus 200 or an external memory accessible by the apparatus 200, for example, a cloud-based storage.

The apparatus 200 may be configured to detect that one or more pixels in the thermal sensor data originating from the thermal sensor triggers at least one threshold value associated with the one or more pixels. Each pixel may have an associated threshold value or threshold values. This may be called also as a normal operational signature (NOS) associated with the environment. The NOS data may be readily available and it may be prestored in a memory accessible to the apparatus 200. In another example embodiment, the apparatus 200 may have monitored the environment for a predetermined amount of time, and the NOS may be generated based on the monitoring and stored in the memory. The NOS may thus determine boundaries for the pixels for a normal operation and it may thus be used for the detection of anomalies in the environment. This analysis may be done continuously and in real-time or substantially in real-time by comparing the results of the thermal sensor inputs with the NOS and searching for pixels with a deviation, for example, a predetermined deviation, from the NOS. When the situation outside the NOS persists for a pre-determined period of time, an interpretation of the situation may be performed. For example, if the thermal sensor provides values that are below the NOS, this can be interpreted, for example, as a machine shut down. If the thermal sensor provides values that are above the NOS, this can be interpreted, for example, as a machine anomaly caused by an increased friction or other internal combustion issues. Thus, a threshold associated with a pixel may comprise, for example, at least one of a lower temperature boundary, an upper temperature boundary for each pixel of the thermal sensor data, a rate of a temperature change and a timing or sequence of change for each pixel of the thermal sensor data. For example, if the threshold value associated with the pixel is exceeded (“upper temperature boundary”) or is less than the threshold value (“lower temperature boundary”), this may provide an indication that the temperature value provided by the thermal sensor data may indicate an anomaly. As another example, the timing or sequence of change for each pixel of the thermal sensor data may be used, for example, to determine if the system loses its synchronization with other parts of the system.

Further, in an example embodiment, objects in the image sensor data may be recognized based on image recognition, for example, based on a machine learning algorithm. Based on the image recognition, it is possible to detect objects in the image sensor data, i.e., in the visible light camera data and then assign NOS values to each object.

The apparatus 200 may further be configured to identify the corresponding one or pixels more (corresponding to the one or more pixels in the thermal sensor data) in the image sensor data originating from the image sensor. In other words, the pixels identified based on the thermal sensor data are identified from the image sensor data. At least one of the corresponding one or more pixels in the image sensor data may then be mapped to at least one pixel of a surface of an object in the dimensionally accurate three-dimensional model. This can be done, for example, by first determining a two-dimensional point of view of a camera in the dimensionally accurate three-dimensional model associated with the environment based on the image sensor data and a location of the image sensor in the environment. This means that a point of view provided by the image sensor is matched with the dimensionally accurate three-dimensional model. This then allows to map the corresponding one or more pixels in the image sensor data to the two-dimensional point of view of the camera in the dimensionally accurate three-dimensional model associated with the environment. When then taking into account the assumption that the anomaly is formed in practice on surfaces and not in air, lines may be drawn from the location of the center of a camera lens in the dimensionally accurate three-dimensional model towards the one or more anomaly pixels mapped to the two-dimensional point of view of the camera in the dimensionally accurate three-dimensional model associated with the environment. A pixel that is one of the one or more pixels mapped to the two-dimensional point of view of the camera in the dimensionally accurate three-dimensional model and also part of a surface of an object in the dimensionally accurate three-dimensional model, can be regarded as an actual location of the anomaly. The location and/or size of the anomaly associated with the surface of the object in the dimensionally accurate three-dimensional model can thus be estimated based on the mapping.

In an example embodiment, depth map data may be obtained based on the dimensionally accurate three-dimensional model, and the data originating from the thermal sensor may be normalized to enable comparison to the at least one threshold associated with each pixel of the thermal sensor data. The use of depth map derived from the dimensionally accurate three-dimensional model of the environment thus enables the normalization of the thermal sensor measurements and therefore eliminating the inaccuracies caused by the impact of distance on the temperature values recorded by the thermal sensor. The normalization of the thermal sensor data may be done because the temperature readings are dependent on the distance from the thermal camera. In order words, using a formula, all the temperature values from the thermal sensor may be normalized or “transferred” to a specific plane, for example, to a measured object plane or one meter away from the object which is where the sensor readings are very close to nominal temperatures. Then the distance impact on the thermal sensor data will be eliminated and it is possible to compare the thermal sensor data with the threshold that can be the nominal temperature of the object.

In another example embodiment, in addition to normalizing the thermal sensor data, also the at least one threshold associated with each pixel of the thermal sensor data may be normalized. Thus, instead of using nominal values for the thresholds, the thermal sensor data and the thresholds may be normalized to some predetermined plane.

Further, each pixel in the dimensionally accurate three-dimensional model may have a depth value. In other words, it is known how far the pixel is from the location of the center of the camera lens in the dimensionally accurate three-dimensional model. The normalization then means that the use of the depth aspect in the dimensionally accurate three-dimensional model of the environment enables the normalization of the thermal sensor measurements and therefore enables the elimination of the inaccuracies caused by the impact of the distance on the temperature values recorded by the thermal sensor.

The normalization thus corresponds to the transfer of pixels from n different distance planes to a prespecified plane by the use of predetermined distance-dependent thermal value multipliers. The normalization thus allows for an accurate and distance independent comparison of the pixel temperatures, temperature variation and also area sizing. While two objects with the same known temperature in different distances present different temperatures and also temperature variations in thermal sensor data, the normalization enables the temperature and its variation for both objects recorded by the thermal sensor to be comparable.

In an example embodiment, when a depth value is associated with the pixels of the dimensionally accurate three-dimensional model, the actual size of the anomaly can be estimated. If the anomaly is a fire, the determination of fire boundary pixels allows for estimating the size of the fire in the dimensionally accurate three-dimensional model. In an example embodiment, material types may be assigned to various objects (for example, floors, walls, tables, furniture etc.) of the environment. This may enable a solution in which a real-time or substantially real-time feed provided based on the dimensionally accurate three-dimensional model may be provided to the fire brigade. Further, based on the size, shape, material and location of the components in the environment, fire propagation can be simulated in real-time to the fire brigade for aiding, for example, the fire extinguishment planning.

Although the above discussion has provided fire as an example of an anomaly, the anomaly may take also other forms. For example, the discussed solution may be used for condition monitoring of any environment where a changed condition causes temperature changes. For example, various machinery or machinery parts may have a certain temperature range in their normal operating state. For example, if it is determined that a machine, machine part is identified to be colder than normally, it may be an indication of a malfunction of the machine or machine part as it may not be functioning any more. Similarly, if it is determined that a machine or machine part is identified to be warmer than normally, it may be an indication of a malfunction of the machine or machine part as it may have overheated. In another example embodiment, a pipe can be monitored using the discussed solution if the temperature of the pipe varies depending on a flow within the pipe. For example, a normal temperature for the pipe may be in a situation when water or other liquid steadily flows in the pipe. When the flow stops or slows, this may cause a change in the temperature of the outer surface of the pipe, and this may then be detected using the discussed solution.

In an example embodiment, a time-dependent risk score associated with the environment may be determined. The term “time-dependent” means, for example, that the risk score reflects the current situation, thus being real-time or substantially real-time. Data from the thermal sensor 204 and the visible light camera 206 may be stored in the memory 202 for historical analysis. The stored data may be integrated to the dimensionally accurate three-dimensional model. The integration of, for example, thermal, color, brightness, and/or object recognition data to the dimensionally accurate three-dimensional model from thermal sensor 204 and the visible light camera 206 may be done by comparing and extracting the changes from the original state of the environment recorded initially by the thermal sensor 204 and the visible light camera 206 and presented originally in the dimensionally accurate three-dimensional model. This may mean, for example, that various objects in the dimensionally accurate three-dimensional model are associated with corresponding data from the thermal sensor 204 and the visible light camera 206. The apparatus 200 may then process the stored data using a risk assessment model to determine a time dependent risk score associated with the environment. The risk score may be associated with the overall environment. Alternatively, different risk scores may be determined for different parts or objects of the environment. For example, an addition of a fuel storage in a facility can lead to a higher fire risk score in the environment while, for example, a machine shutting down or removal of flammable dust or gases from the environment can lead to a lower risk score. The risk assessment model may be based on an original score assessment of an environment risk that can be performed on the original dimensionally accurate three-dimensional model of an environment. Every time that a change is introduced in the environment, the thermal, color, brightness, and/or object recognition data from thermal sensor 204 and the visible light camera 206 may be extracted and compared to the original historical data integrated in the original dimensionally accurate three-dimensional model. The result of each change detected by the comparison of the current data and original data integrated in the dimensionally accurate three-dimensional model can result in a pre-determined increase or decrease in the original environment risk score. The aggregation of all the changes may determine the overall change in the risk score at any time. This means that all changes detected by the thermal sensor 204 and the visible light camera 206 and integrated in the dimensionally accurate three-dimensional model at any time determine the overall change to the risk score of the environment at that time*. In an example embodiment, the apparatus 200 may also aggregate risk score changes captured by different sensors. The time dependent risk score associated with the environment may be provided, example, by displaying it in the dimensionally accurate three-dimensional model. Alternatively or additionally, an alarm may be triggered if the time dependent risk score reaches a predetermined threshold. The alarm may be transmitted, for example, to a service entity or a building manager.

The risk assessment model may thus be configured to take into account historical data and real-time data from the thermal sensor, the image sensor and the depth map from the dimensionally accurate three-dimensional model to provide a more accurate risk assessment. The risk score may be displayed on a graphical user interface or in the real-time dimensionally accurate three-dimensional model, and may be used to trigger alerts or other actions in response to changes in the risk score level. The risk score may be, for example, a fire risk score or an anomaly risk score for the environment or part of the environment, and the risk score may be time-dependent score that changes when the dimensionally accurate three-dimensional model changes. The (original) initial risk score may be calculated based on the dimensionally accurate three-dimensional model using a predefined risk score formula and it may be updated in real time according to the environmental changes registered by all the sensors. The risk score associated with the environment may also be useful information for an insurance company.

As already discussed above, the anomaly associated with the object in the dimensionally accurate three-dimensional model may be visualized or provided for visualization. The visualization may be performed, for example, with an apparatus or a display that may be locally connected to the apparatus 200 or communicatively connected to the apparatus 200 via data communication, for example, via a data communication network. The visualization may be presented in real-time, substantially in real-time or with a known delay, for example, five or ten seconds. In case of a fire, flames may be provided on the object, or alternatively the object may be somehow otherwise emphasized. Temperature readings may also be provided together with the visualization. In another example embodiment, an alarm associated with the anomaly associated with the object in the dimensionally accurate three-dimensional model may be triggered. The alarm may be triggered in real-time, substantially in real-time or with a known delay, for example, five or ten seconds. Thus, this may enable quick response times to the detected anomaly.

Further, although the various examples and embodiments may have been illustrated with a single thermal sensor and image sensor, multiple thermal sensors and image sensors may be used in the environment. This allows for resolving a blind spot issue as the thermal sensor and the image sensor may both be direct line of sight sensors.

The apparatus 200 may be communicatively connected to a real-time feed recipient 208. The real-time feed recipient 208 may be, for example, a service center, a security guard, a fire brigade or any other entity that may monitor the real-time feed.

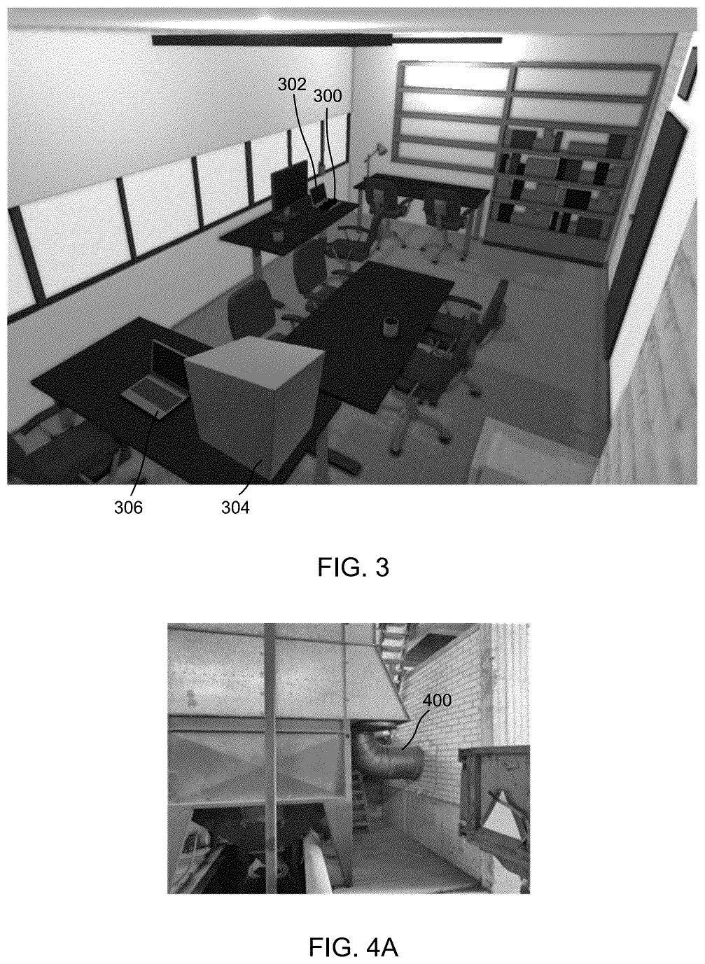

FIG. 3 illustrates an example view of a dimensionally accurate three-dimensional model according to an example embodiment. FIG. 3 illustrates an anomaly 300 associated with a computer 302 on a table. In this case, the anomaly 300 has been visualized in the dimensionally accurate three-dimensional model of an environment. In this example embodiment, the environment is a closed space, for example, a room. The anomaly 300 may represent, for example, overheating fire associated with the computer 302.

In an example embodiment, the dimensionally accurate three-dimensional model of an environment may comprise one or more three-dimensional exclusion zones. An exclusion zone excludes a volume determined by the at least one three-dimensional exclusion zone when estimating the location and/or size of the anomaly associated with the object in the dimensionally accurate three-dimensional model based on the mapping. An exclusion zone may be a volume that is considered as a low fire hazard volume but it may still be a volume that creates a significant number of false alarms due to, for example, processes or events that include working with very high temperature equipment and systems, for example, including soldering, welding etc. As each pixel of the dimensionally accurate three-dimensional model may be associated with a depth value (i.e. distance), this allows an evaluation whether the temperature data collected from the environment belongs to the three-dimensional exclusion zone or not. In FIG. 3 a cube 304 on a table near a laptop 306 is a three-dimensional exclusion zone which is associated with a low-risk area of the environment. During monitoring of the environment, the excluded three-dimensional zones are exempted from monitoring and therefore cannot trigger false alarms, for example, fire alarms.

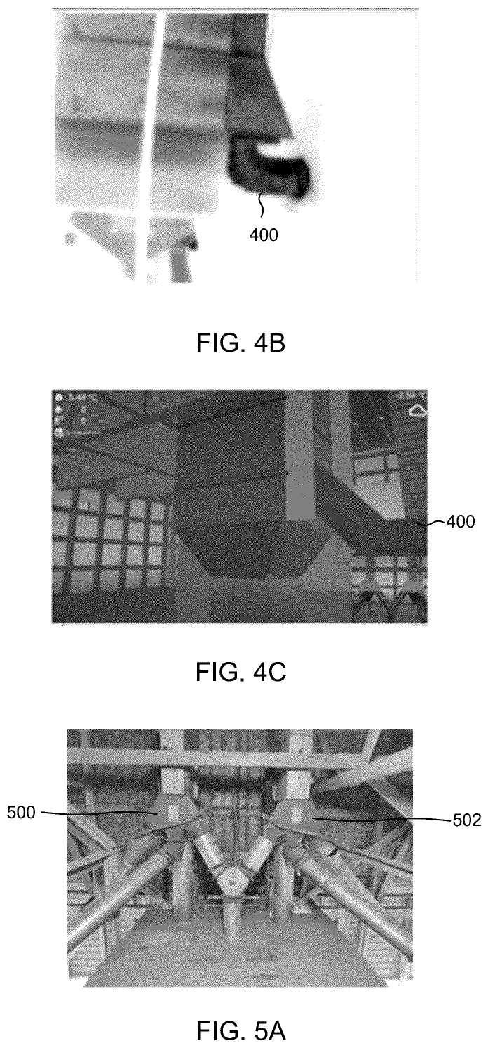

FIG. 4A illustrates an example of a visible light sensor image of a dryer according to an example embodiment. FIG. 4B illustrates an example of a thermal sensor image of the dryer according to an example embodiment. FIG. 4C illustrates an example of a dimensionally accurate three dimensional model of the dryer according to an example embodiment.

As can be seen from FIG. 4C, the dimensionally accurate three-dimensional model models the environment illustrated in FIG. 4A. Based on the thermal sensor image illustrated in FIG. 4B, it can be seen that a blower pipe 400 is hot when the dryer has been operational. However, no alerts are triggered and the dimensionally accurate three-dimensional model does not visualize any anomalies.

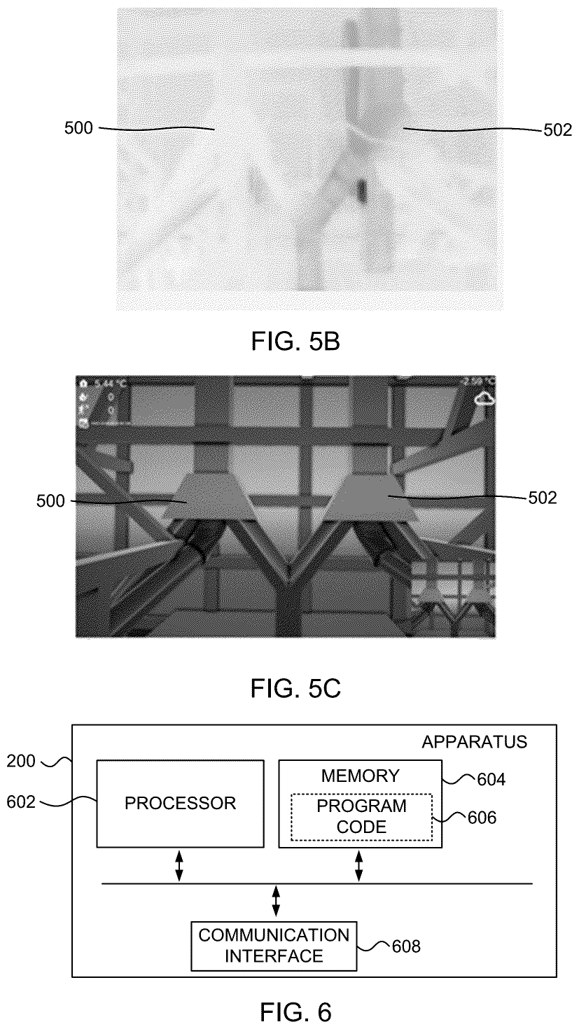

FIG. 5A illustrates an example of a visible light sensor image of a grain dryer according to an example embodiment. FIG. 5B illustrates an example of a thermal sensor image of the grain dryer according to an example embodiment. FIG. 5C illustrates an example of a dimensionally accurate three dimensional model of the grain dryer according to an example embodiment.

As can be seen from FIG. 5C, the dimensionally accurate three-dimensional model models the environment comprising two electric motors 500, 502 illustrated in FIG. 5A. Based on the thermal sensor image illustrated in FIG. 5B, it can be seen that the electric motor 502 is operational as heat is provided. However, no alerts are triggered and the dimensionally accurate three-dimensional model does not visualize any anomalies.

FIG. 6 illustrates an example of an apparatus 200 configured to practice one or more example embodiments. The apparatus 200 may comprise, for example, a computer or a server computer, or in general a device configured to implement the functionality described herein. Although the apparatus 200 is illustrated as a single device, it is appreciated that, wherever applicable, functions of the apparatus 200 may be distributed to a plurality of devices.

The apparatus 200 may comprise at least one processor 602. The at least one processor 602 may comprise, for example, one or more of various processing devices or processor circuitry, such as, for example, a co-processor, a central processing unit (CPU), an accelerated processing unit (APU), a microprocessor, a controller, a Digital Signal Processor (DSP), processing circuitry with or without an accompanying DSP, or various other processing devices including integrated circuits such as, for example, an Application Specific Integrated Circuit (ASIC), a Field Programmable Gate Array (FPGA), a Microcontroller Unit (MCU), a hardware accelerator, a special-purpose computer chip, or the like.

The apparatus 200 may further comprise at least one memory 604. The at least one memory 604 may be configured to store, for example, computer program code or the like, for example, operating system software, application software, normal operation signature (NOS) data, threshold data associated with the NOS, an object recognition machine learning algorithm to detect objects in the image sensor image etc. The at least one memory 604 may comprise one or more volatile memory devices, one or more non-volatile memory devices, and/or a combination thereof. For example, the at least one memory 604 may be embodied as magnetic storage devices (such as hard disk drives, floppy disks, magnetic tapes, solid-state drives (SSD) (for example, a secure digital (SD) card, a non-volatile memory express (NVMe) drive) etc.), optical magnetic storage devices, or semiconductor memories (such as mask ROM, PROM (programmable ROM), EPROM (erasable PROM), flash ROM, RAM (random access memory), etc.).

The apparatus 200 may further comprise a communication interface 608 configured to enable the apparatus 200 to transmit and/or receive information to/from other devices. In one example, the apparatus 200 may use the communication interface 608 to transmit or receive signaling information and data in accordance with at least one data communication or cellular communication protocol. The communication interface 608 may be configured to provide at least one wireless radio connection, such as, for example, a 3GPP mobile broadband connection (e.g. 3G, 4G, 5G, 6G etc.), Wi-Fi, Bluetooth etc. The communication interface 608 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas. The communication interface 608 may comprise a receiver, a transmitter or a transceiver.

When the apparatus 200 is configured to implement some functionality, some component and/or components of the apparatus 200, for example, the at least one processor 602 and/or the at least one memory 604, may be configured to implement this functionality. Furthermore, when the at least one processor 602 is configured to implement some functionality, this functionality may be implemented using the program code 606 comprised, for example, in the at least one memory 604.

The functionality described herein may be performed, at least in part, by one or more computer program product components such as software components. According to an embodiment, the apparatus may comprise a processor or processor circuitry, for example, a microcontroller, configured by the program code when executed to execute the embodiments of the operations and functionality described herein. The program code 606 is provided as an example of instructions which, when executed by the at least one processor 602, cause performance of apparatus. Alternatively, or in addition, the functionality described herein can be performed, at least in part, by one or more hardware logic components. For example, and without limitation, illustrative types of hardware logic components that can be used include Field-programmable Gate Arrays (FPGAS), Application-Specific Integrated Circuits (ASICS), Application-Specific Standard Products (ASSPs), System-on-a-chip systems (SOCs), Complex Programmable Logic Devices (CPLDs), CPUS, APUs and Graphics Processing Units (GPUs).

The apparatus 200 may be configured to perform or cause performance of any aspect of the method (s) described herein. Further, a computer program may comprise instructions for causing, when executed, an apparatus to perform any aspect of the method (s) described herein. The computer program may be stored on a computer-readable medium. Further, the apparatus 200 may comprise means for performing any aspect of the method (s) described herein. In one example, the means may comprise the at least one processor 602, the at least one memory 604 including the program code 606 (instructions) configured to, when executed by the at least one processor 602, cause the apparatus 200 to perform the method (s). In general, computer program instructions may be executed on means providing generic processing functions. The method (s) may be thus computer-implemented, for example, based algorithm (s) executable by the generic processing functions, an example of which is the at least one processor 602. The means may comprise transmission and/or reception means, for example one or more radio transmitters or receivers, which may be coupled or be configured to be coupled to one or more antennas, or transmitter (s) or receiver (s) of a wired communication interface.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations as (such implementations in only analog and/or digital circuitry) and (b) combinations of hardware circuits and software, such as (as applicable): (i) a combination of analog and/or digital hardware circuit (s) with software/firmware and (ii) any portions of hardware processor (s) with software (including digital signal processor (s)), software, and memory (ies) that work together to cause an apparatus, such as a mobile phone or server, to perform various functions) and (c) hardware circuit (s) and or processor (s), such as a microprocessor (s) or a portion of a microprocessor (s), that requires software (e.g., firmware) for operation, but the software may not be present when it is not needed for operation. This definition of circuitry applies to all uses of this term in this application, including in any claims.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. A computer-implemented method for estimating an anomaly in an environment, the method comprising:
obtaining, from a memory, a dimensionally accurate three-dimensional model associated with the environment, the dimensionally accurate three-dimensional model providing a three-dimensional position of objects in the environment;
obtaining thermal sensor data originating from a thermal sensor and image sensor data originating from an image sensor arranged in the environment, the thermal sensor data and image sensor data comprising substantially real-time sensor data associated with the environment, the thermal sensor and image sensor having known locations in the dimensionally accurate three-dimensional model;
mapping locations of image pixels in the thermal sensor data, the image sensor data and a point of view of a camera associated with the dimensionally accurate three-dimensional model; and
estimating at least one of a location and size of an anomaly indicated by the thermal sensor data based on the mapping, the anomaly being associated with an object in the dimensionally accurate three-dimensional model.

2. The computer-implemented method of claim 1, further comprising:
visualizing the anomaly associated with the object in the dimensionally accurate three-dimensional model.

3. The computer-implemented method of claim 1, further comprising:
triggering an alarm associated with the anomaly associated with the object in the dimensionally accurate three-dimensional model.

4. The computer-implemented method of claim 1, further comprising:
detecting that one or more pixels in the thermal sensor data originating from the thermal sensor triggers at least one threshold associated with the one or more pixels;
identifying the corresponding one or more pixels in the image sensor data originating from the image sensor;
mapping at least part of the corresponding one or more pixels in the image sensor data to at least one pixel of a surface of an object in the dimensionally accurate three-dimensional model; and
estimating the at least one of location and size of the anomaly associated with the surface of the object in the dimensionally accurate three-dimensional model based on the mapping.

5. The computer-implemented method of claim 4, further comprising:
determining a two-dimensional point of view of a camera in the dimensionally accurate three-dimensional model associated with the environment based on the image sensor data and a location of the image sensor in the environment;
mapping the corresponding one or more pixels in the image sensor data to the two-dimensional point of view of the camera in the dimensionally accurate three-dimensional model associated with the environment;
determining one or more pixels associated with the surface of the object that correspond with the at least part of the corresponding one or more pixels in the image sensor data; and
estimating the at least one of location and size of the anomaly associated with the surface of the object in the dimensionally accurate three-dimensional model based on the one or more pixels associated with the surface of the object.

6. The computer-implemented method of claim 4, further comprising:
obtaining, from the memory, a normal operational signature associated with the environment, the normal operational signature determining the at least one threshold associated with each pixel of the thermal sensor data.

7. The computer-implemented method of claim 4, wherein the at least one threshold associated with each pixel of the thermal sensor data comprises at least one of:
a lower temperature boundary for each pixel of the thermal sensor data;
an upper temperature boundary for each pixel of the thermal sensor data;
a rate of a temperature change for each pixel of the thermal sensor data; and
a timing or sequence of change for each pixel of the thermal sensor data.

8. The computer-implemented method of claim 4, wherein the at least one threshold associated with each pixel of the thermal sensor data is normalized, and the method further comprising:
obtaining depth map data based on the dimensionally accurate three-dimensional model; and
normalizing the thermal sensor data originating from the thermal to enable comparison to the at least one threshold associated with each pixel of the thermal sensor data.

9. The computer-implemented method of claim 1, further comprising:
obtaining, from the memory, at least one three-dimensional exclusion zone associated with the dimensionally accurate three-dimensional model associated with the environment; and
excluding a volume determined by the at least one three-dimensional exclusion zone when estimating the at least one of location and size of the anomaly associated with the object in the dimensionally accurate three-dimensional model based on the mapping.

10. The computer-implemented method of claim 1, further comprising:
storing the thermal sensor data and image sensor data in the memory for historical analysis;
integrating the stored data to the dimensionally accurate three dimensional model;
processing the stored data using a risk assessment model to determine a time dependent risk score associated with the environment; and
providing the time dependent risk score associated with the environment.

11. The computer-implemented method of claim 10, further comprising:
displaying the time dependent risk score in the dimensionally accurate three-dimensional model.

12. The computer-implemented method of claim 10, further comprising:
triggering an alarm if the time dependent risk score reaches a predetermined threshold.

13. An apparatus comprising
at least one processor; and
at least one memory storing instructions, that when executed by the at least one processor, cause the apparatus to perform:
obtaining, from a memory, a dimensionally accurate three-dimensional model associated with the environment, the dimensionally accurate three-dimensional model providing a three-dimensional position of objects in the environment;
obtaining thermal sensor data originating from a thermal sensor and image sensor data originating from an image sensor arranged in the environment, the thermal sensor data and image sensor data comprising substantially real-time sensor data associated with the environment, the thermal sensor and image sensor having known locations in the dimensionally accurate three-dimensional model;
mapping locations of image pixels in the thermal sensor data, the image sensor data and a point of view of a camera associated with the dimensionally accurate three-dimensional model; and
estimating at least one of a location and size of an anomaly indicated by the thermal sensor data based on the mapping, the anomaly being associated with an object in the dimensionally accurate three-dimensional model based.

14. The apparatus of claim 13, wherein the instructions, when executed by the at least one processor, cause the apparatus to perform:
visualizing the anomaly associated with the object in the dimensionally accurate three-dimensional model.

15. The apparatus of claim 13, wherein the instructions, when executed by the at least one processor, cause the apparatus to perform:
triggering an alarm associated with the anomaly associated with the object in the dimensionally accurate three-dimensional model.

16. The apparatus of claim 13, wherein the instructions, when executed by the at least one processor, cause the apparatus to perform:
detecting that one or more pixels in the thermal sensor data originating from the thermal sensor triggers at least one threshold associated with the one or more pixels;
identifying the corresponding one or more pixels in the image sensor data originating from the image sensor;
mapping at least part of the corresponding one or more pixels in the image sensor data to at least one pixel of a surface of an object in the dimensionally accurate three-dimensional model; and
estimating the at least one of location and size of the anomaly associated with the surface of the object in the dimensionally accurate three-dimensional model based on the mapping.

17. The apparatus of claim 16, wherein the instructions, when executed by the at least one processor, cause the apparatus to perform:
determining a two-dimensional point of view of a camera in the dimensionally accurate three-dimensional model associated with the environment based on the image sensor data and a location of the image sensor in the environment;
mapping the corresponding one or more pixels in the image sensor data to the two-dimensional point of view of the camera in the dimensionally accurate three-dimensional model associated with the environment;
determining one or more pixels associated with the surface of the object that correspond with the at least part of the corresponding one or more pixels in the image sensor data; and
estimating the at least one of location and size of the anomaly associated with the surface of the object in the dimensionally accurate three-dimensional model based on the one or more pixels associated with the surface of the object.

18. The apparatus of claim 16, wherein the instructions, when executed by the at least one processor, cause the apparatus to perform:
obtaining, from the memory, a normal operational signature associated with the environment, the normal operational signature determining at least one threshold associated with each pixel of the thermal sensor data.

19. The apparatus of claim 13, wherein the at least one threshold associated with each pixel of the thermal sensor data comprises at least one of:
a lower temperature boundary for each pixel of the thermal sensor data;
an upper temperature boundary for each pixel of the thermal sensor data;
a rate of a temperature change for each pixel of the thermal sensor data; and
a timing or sequence of change for each pixel of the thermal sensor data.

20. The apparatus of claim 16, wherein the at least one threshold associated with each pixel of the thermal sensor data is normalized, and the instructions, when executed by the at least one processor, cause the apparatus to perform:
obtaining depth map data based on the dimensionally accurate three-dimensional model; and
normalizing the thermal sensor data originating from the thermal sensor based on the depth map data to enable comparison to the at least one threshold associated with each pixel of the thermal sensor data.

21. The apparatus of claim 13, wherein the instructions, when executed by the at least one processor, cause the apparatus to perform:
obtaining, from the memory, at least one three-dimensional exclusion zone associated with the dimensionally accurate three-dimensional model associated with the environment; and
excluding a volume determined by the at least one three-dimensional exclusion zone when estimating the at least one of location and size of the anomaly associated with the object in the dimensionally accurate three-dimensional model based on the mapping.

22. The apparatus of claim 13, wherein the instructions, when executed by the at least one processor, cause the apparatus to perform:
storing the thermal sensor data and image sensor data in the memory for historical analysis;
integrating the stored data to the dimensionally accurate three dimensional model;
processing the stored data using a risk assessment model to determine a time dependent risk score associated with the environment; and
providing the time dependent risk score associated with the environment.

23. The apparatus of claim 22, wherein the instructions, when executed by the at least one processor, cause the apparatus to perform:
displaying the time dependent risk score in the dimensionally accurate three-dimensional model.

24. The apparatus of claim 22, wherein the instructions, when executed by the at least one processor, cause the apparatus to perform:
triggering an alarm if the time dependent risk score reaches a predetermined threshold.

25. A system comprising:
a thermal sensor configured to provide substantially real-time thermal sensor data associated with an environment, the thermal sensor having a known location with respect to a dimensionally accurate three-dimensional model associated with the environment;
an image sensor configured to provide substantially real-time image sensor data associated with the environment, the image sensor having a known location with respect to the dimensionally accurate three-dimensional model associated with the environment;
a memory comprising the dimensionally accurate three-dimensional model associated with the environment; and
an apparatus of claim 13.

26. A computer program comprising non-transitory machine readable instructions for causing an apparatus to carry out the method of claim 1.
